(19) United States
(12) Patent Application Publication
(10) Pub. No.: US 2004/0187646 A1
(43) Pub. Date: Sep. 30, 2004

(54) Stud installation and stud removal tool set

(75) Inventors: Michael L. Whitehead, Clarinda, IA (US); Randy Kubick, Aurora, CO (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA

(21) Appl. No.: 10/401,156

(22) Filed: Mar. 27, 2003

(51) Int. Cl. B25B 13/50

(52) U.S. Cl. 81/53.2

(57) ABSTRACT

A set of tools for installation and a set of tools for removal of studs from a work piece are disclosed. The installation tools include body member with a removable bearing that can be set against the head of a stud that is to be installed in a workpeice. The stud removal tools include a pair of body members which are each mounted on the stud to be removed and tightened against one another so that one of the body members may be rotated to effect removal of a stud.

### BACKGROUND OF THE INVENTION

In a principal aspect the present invention relates to tools for installation and removal of threaded studs.

Studs are used for many purposes in various mechanical devices such as vehicle engines. Typically studs are threaded rods which come in various diameters and thread types. The rods are headless. In other words, there is no polygonal head or slot typically at the top end of the stud. Thus, the stud may be partially placed or threaded in an engine block, for example. The threads of the exposed stud may then be utilized for attachment of a fastener, for example, to retain a separate component part attached to the block.

Various devices have been available for installation and removal of threaded studs. For example, threaded collets may be placed on a stud and tightened thereon. The collet may then be rotated to remove or install a stud. Other types of tools have also been proposed for installation and removal of studs. Nonetheless, there has remained the need for improved tools having the function of installation or removal of a stud. Such need inspired the development of the present invention.

### SUMMARY OF THE INVENTION

Briefly, the present invention comprises a tool for installation of a threaded stud and a tool for removal of a threaded stud. The installation tool includes a body member with a polygonal external configuration and an axial throughbore having threads at a stud thread engaging end or passage of the throughbore as well as an enlarged counterbore at the opposite end for receipt of a ball bearing and a set screw. The set screw engages the ball bearing tightly within the interior of the throughbore adjacent the threads inasmuch as the counterbore and ball bearing diameter are greater than the diameter of the threaded end or passage. The body member threaded passage may then be threaded onto a stud with the ball bearing engaged tightly against the top of the stud. The installation tool thus comprises a polygonal head for the stud and may be rotated to insert and drive the stud into a threaded opening. To remove the installation tool from the top of the stud, the tool is simply rotated in the opposite direction. The smooth hardened ball rests on the center line of the stud, allowing the tool to be easily unscrewed or removed from the installed stud. The installation tool is provided in numerous sizes to accommodate studs of numerous sizes.

The stud removal tool includes a first body member which is threaded onto a stud that is to be removed. A second body member having a smaller diameter or smaller sized head than the first body member is also threaded onto the same stud and tightly engaged against the first body member. Both the first body member and the second body member include a throughbore with threads compatible with the associated stud. The first body member may then be reverse, torqued or turned to remove the stud. Again, the tools are provided in a set in order to accommodate various sizes or studs.

Thus, it is an object of the invention to provide an improved stud installation and stud removal tool.

It is a further object of the invention to provide stud installation tools and stud removal tools that are provided in a set of such tools to accommodate various sized studs for the purpose of installation or removal thereof.

Another object of the invention is to provide a stud installation tool which is rugged, economical, easy to use and which will avoid damage of studs during installation.

Still a further object of the invention is to provide a stud removal tool which is economical, easy to use, and which will not damage studs during their removal.

These and other objects, advantages and features of the invention will be set forth in the detailed description which follows.

### BRIEF DESCRIPTION OF THE DRAWINGS

In the detailed description which follows, reference will be made to the drawing comprised of the following figures:

FIG. 1 is a side elevation of a stud installation tool in accord with the invention;

FIG. 2 is a top plan view of the installation tool of FIG. 1;

FIG. 3 is a cross sectional view of the tool of FIG. 2 taken along the line 3-3;

FIG. 4 is a sectional view of the body member of the tool of FIG. 1;

FIG. 5 is an exploded isometric view of the tool of FIG. 1;

FIG. 6 is a cross sectional view of the tool of FIG. 1 as it is installed on a stud;

FIG. 7 is a side elevation of the stud removal tool of the invention;

FIG. 8 is a top plan view of the tool of FIG. 7;

FIG. 9 is a sectional view of the tool of FIG. 8 taken along the line 9-9;

FIG. 10 is an exploded isometric view of the tool of FIG. 9;

FIG. 11 is an exploded sectional view of the tool of FIG. 9 as positioned on a stud;

FIG. 12 is a sectional view of the tool of FIG. 9 as it is positioned on a stud for engagement and turning by a wrench to remove a stud;

FIG. 13 is a series of the stud installation tools comprising a set of such tools; and

FIG. 14 is a series of the stud removal tools in a set.

### DESCRIPTION OF THE PREFERRED EMBODIMENT

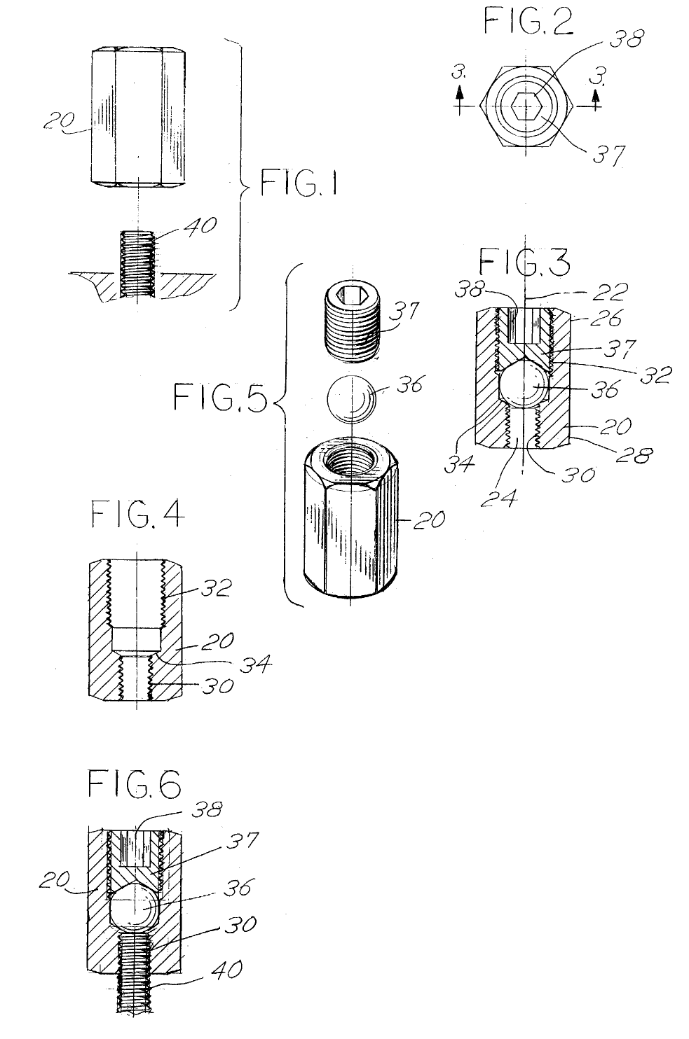

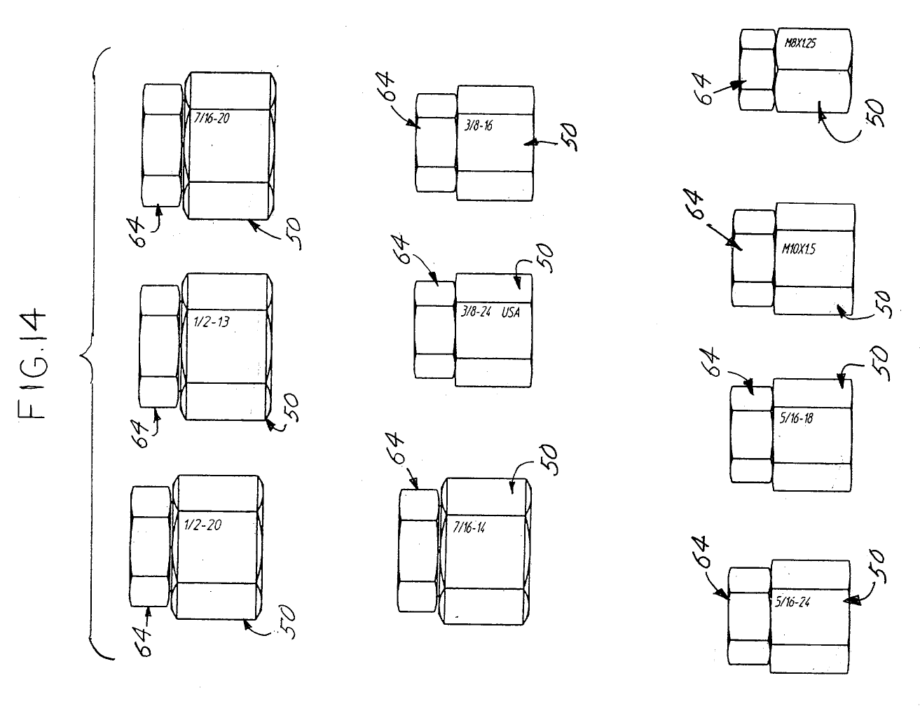

FIGS. 1-7 illustrate the stud installation tool, or more particularly, a single embodiment of a stud installation tool. FIGS. 9-13 illustrate a single version of a stud removal tool. FIG. 14 illustrates sets of such tools useful for installation or removal of studs.

Referring therefore first to FIGS. 1-7, an installation tool is provided for each size of standard stud. Thus, a description of a single stud installation tool applies to each of the tools in a set of such tools wherein each of said tools is constructed or made for cooperation with and engagement with a standard size stud. As depicted in FIGS. 1-7, the stud installation tool includes a body member 20 with a longitudinal axis 22. An axial throughbore 24 extends from a drive tool engaging end 26 through the body member 20 and through a thread engaging end 28. The axial throughbore includes a first threaded section 30 which is threaded to match a particular stud size. The throughbore 24 further includes a threaded drive tool engaging end section of the throughbore 24; namely, section 32 having a diameter greater than the diameter of the threaded end 30. A circumferential land 34 is defined and provides a support surface between the bore 32 and the bore 30. A ball bearing 36 sized to fit within the counterbore 32 is fitted against the land 34 and a set screw 37 comprising a bearing retainer and drive member, is threaded into the counterbore 32 to tightly retain the ball bearing 36 in position. The set screw 37 includes a hexagonal counterbore 38 for receipt of an Allen wrench, for example, so that the set screw 37 can be tightened tightly against the ball bearing 36. The body member 20 has a hexagonal or other polygonal outer shape or configuration (at least in part) so that it may be turned by a wrench or the like.

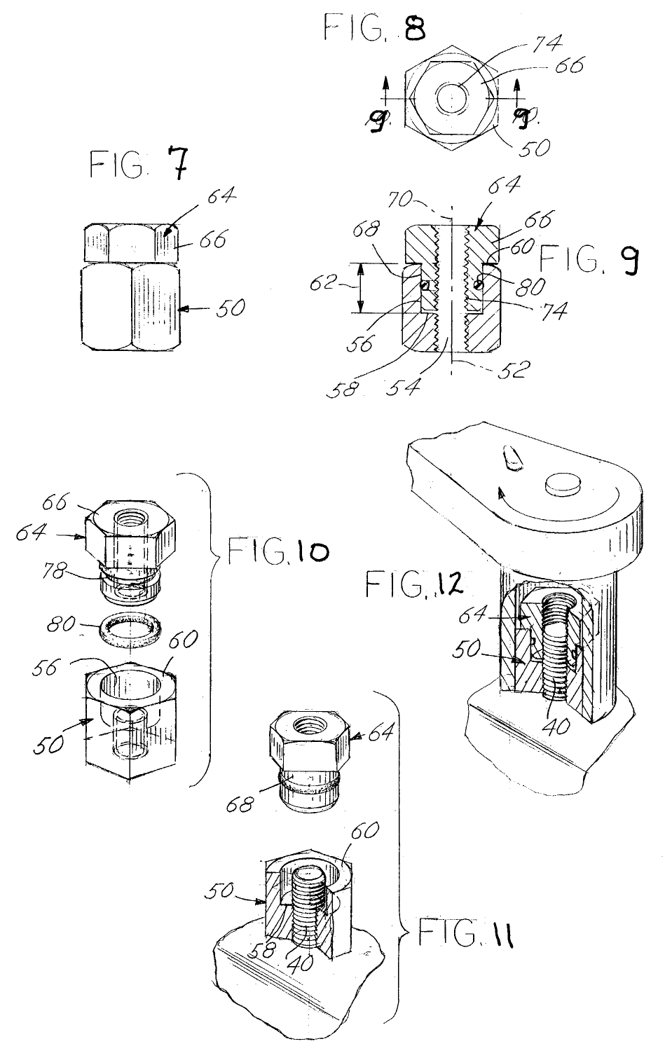

In use, the body member 20 is threaded onto a stud 40 which has a size that is compatible with the threaded opening 30. When threaded on the stud 40, the installation tool is in the configuration, for example, as illustrated in FIG. 3. That is, the set screw 37 tightly retains the bearing 36 in position in counterbore 32. The installation tool may then be turned as depicted in FIG. 6 so that the stud 40 will be threaded into a block, for example.

Upon threading the stud 40 by means of the stud installer into a block or other threaded member passage, it will be necessary to remove the installation tool. This is done by rotating the tool in the opposite direction. The smooth hard surface of the ball resting on the center line of the stud 40 allows the tool to be easily unscrewed or removed from the stud 40. In the unusual situation where such technique my not be effective, the set screw 37 may be loosened to release the ball 36 from engaging the stud 40.

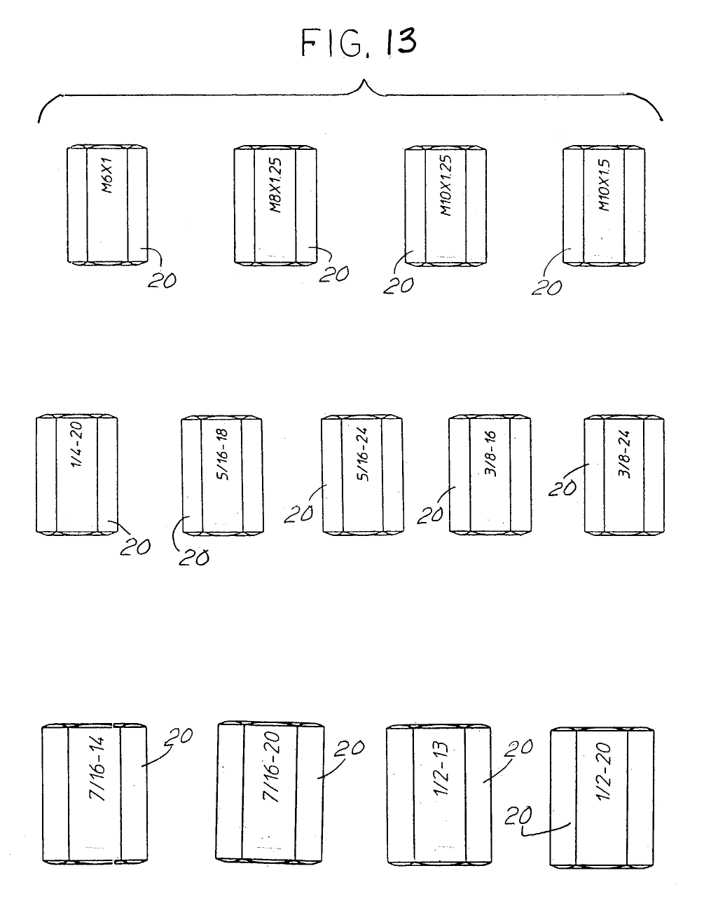

Referring next to FIGS. 8-12 there is illustrated a stud removal tool. Again, each tool is customized to cooperate with a particular size of stud in order to effect removal thereof. The stud removal tool includes two basic parts. A first body member 50 having a hexagonal outer configuration and a center line axis 52 is provided with an axial throughbore 54 that is compatible with the threads of the stud to be removed. The first body member 50 further includes a large diameter counterbore 56 which exceeds the bore size of the stud engaging bore 54. The counterbore 56 is not threaded. Rather, it is an axial, cylindrical counterbore which defines a land surface 58 spaced from a top edge surface 60 by a fixed distance 62.

The stud removal tool further includes a second body member 64 having hexagonal head 66 which comprises a top end section and a lower, bottom, projecting section 68. The second body member 64 further includes an axis 70 which, when the component body members 50 and 64 are joined as described hereinafter, is coaxial with the axis 52.

The second body member 64 further includes an axial threaded counterbore 74 which has a diameter and thread configuration substantially identical to the threaded bore 54 of first body member 50. It is to be noted that the maximum transverse or lateral dimension of the head section 66 of the second body member 64 is no greater than the minimum transverse or lateral dimension of the first body member 50. This feature is illustrated in FIG. 9 where the head section 66 is shown as being within the periphery of the cross sectional configuration of the first body member 50. Thus, the first body member 50 may be rotated by means of a wrench without engaging the polygonal section 66 of the second body member 64.

The cylindrical projection from the underside head section 66; namely, the projection 68, includes a peripheral groove 78 with an 0-ring 80. This arrangement provides for frictional fit between the first body member 50 and the second body member 64 and further enables the second body member 64 to be rotated about the axis 70 independent from the first body member 50.

In order to effect removal of a stud which is engaged in some workpiece, the first body member 50 and the second body member 64 are threaded upon the stud to be removed. The first body member need not be tightly threaded, or in other words, need not be threaded to the workpiece. Rather, the first body member 50 is threaded onto the end of the stud in a manner which will enable the second body member 64, and more particularly, the bore 74 to be likewise threaded onto the stud. The second body member 64 is then tightened onto the stud so as to tightly engage the underside of the head section 66 against the top surface 60 of body member 50. By so engaging the stud to be removed and by so engaging the second body member 64 frictionally and tightly against the first body member 50, there is, in effect, created a head for the stud which will enable removal of the stud from a work piece. That is, the first body member 50 may be engaged by a turning tool (wrench) to unscrew the stud.

It is to be noted that the axial projection of the bottom section 68 downwardly into the first body member 50 is such that it is less than the dimension 62 which is the distance between the top 60 and the land 58 of member 50. This ensures that the second body member 64 may be tightly engaged with a stud and with the body member 50 by engaging the top surface 60.

Upon tightening of the two body members 50 and 64 on a stud, a wrench is engaged over the outer polygonal surface of the first body member 50 and rotated in reverse to unscrew a stud from a workpiece. For example, the socket may be engaged over the top body member 64 to engage with the second or bottom body member 50 so as to rotate the assembly including the stud.

It is to be noted that the stud removal construction of the invention constitutes an improvement over the so-called double nut method of engaging a stud to effect removal of a stud. The double nut method requires utilization of two nuts of the same size that match the stud size. One nut is placed on the stud and the second nut is then tightened on the stud against the first nut until the outer hexagonal or other polygonal configuration of the two nuts are aligned. When so aligned, then a socket or wrench may be utilized to twist the stud from the workpiece.

The construction of the present invention provides improvements relative to this described arrangement. First, the friction of the engagement of the underside of head section 66 of second body member 64, to the top surface 60 of first body member 50 will be carefully controlled without the necessity of lining up the polygonal exterior surfaces. Second, the second body member 64 is retained in a desired relationship and position with respect to the first body member 50 by means of the frictional interaction generated by the O-ring 80 in the slot 78. Thus, the removal tool of the present invention may be utilized to effect removal of a stud based upon the size of the bore 54 which is compatible with a particular size of stud.

In practice, a full set of installation and removal tools is provided. FIGS. 13 and 14 illustrate, by way of example, the sizing and appearance of such a full set of stud removal and stud installation tools as labeled on the separate tools in FIGS. 13 and 14. Following is a table wherein the size of the stud installation and stud removal tools is set forth.

TABLE 1

| | INSTALLATION | REMOVAL |
|---|---|---|
| STUD SIZE | TOOL | TOOL |
| M6 × 1-6 g | 71010.70 | 71140.70 |
| M8 × 1.25-6 g | 71020.70 | 71150.70 |
| M10 × 1.25-6 g | 71030.70 | 71160.70 |
| M10 × 1.5-6 g | 71040.70 | 71170.70 |
| ¼ - 20 UNC - 2A | 71050.70 | 71180.70 |
| 5/16 - 18 UNC - 2A | 71060.70 | 71190.70 |
| 5/16 - 24 UNF - 2A | 71070.70 | 71200.70 |
| 3/8 - 16 UNC - 2A | 71080.70 | 71210.70 |
| 3/8 - 24 UNF - 2A | 71090.70 | 71220.70 |
| 7/16 - 14 UNC - 2A | 71100.70 | 71230.70 |
| 7/16 - 20 UNF - 2A | 71110.70 | 71240.70 |
| ½ - 13 UNC - 2A | 71120.70 | 71250.70 |
| ½ - 20 UNF - 2A | 71130.70 | 71260.70 |

It is possible to vary the construction of the invention by changing the shape, for example, of the outside polygonal configuration of the various elements. The shape and configuration of the bores and retainer bearings is also adjustable or may be varied. The invention, therefore is to be limited only by the following claims and equivalanets thereof.

What is claimed is:

1. A tool for installation of a threaded stud comprising, in combination:
a body member having an axial throughbore, said body member having a thread engaging end and a drive tool engaging end,
said throughbore having a center line axis, said throughbore also having stud compatible threads at the thread engaging end,
said throughbore having a larger bore at the drive tool engaging end with a land connecting the thread engaging end and larger bore;
a bearing member in the larger bore fitted against the land and projecting into the thread engaging end;
a bearing retainer member located in the larger bore for retaining the bearing tightly in the throughbore.

2. The tool of claim 1 wherein the bearing is a ball bearing.

3. The tool of claim 1 or claim 2 including a drive element for the bearing retainer comprising a polygonal recess.

4. The tool of claim 1 wherein the drive element of the retainer comprises an axial, polygonal recess.

5. The tool of claim 1 wherein the body has a polygonal cross section transverse to the axis.

6. The tool of claim 4 wherein the body has a polygonal cross section transverse to the axis.

7. The tool of claim 1 wherein the bearing has a stud engaging end congruent with the axis of the throughbore.

8. A set of uniquely sized tools of claim 1, claim 2, claim 4, claim 5, claim 6 or claim 7 wherein each tool of the set includes a uniquely sized thread engaging end.

9. A tool for removal of a threaded stud comprising, in combination:
a first body member having a first end with an axial threaded bore compatible with a uniquely sized threaded stud, said body member further including a polygonal cross sectional shape transverse to the axial bore, said body member further including a second end with an axial counterbore in the second end of the body member having a diameter greater than the axial threaded bore and having an axial depth; and
a second body member having a longitudinal axis, a top polygonal section and a bottom projection, said top polygonal section having a maximum dimension transverse to the longitudinal axis less than the minimum dimension transverse to the axis of the polygonal portion of the first body member, said bottom projection frictionally fitted into the first body member counterbore with the axes of the body members aligned whereby the second body member may be rotated about the axis within the first body member, said second body member further including an axial threaded bore compatible with the threaded stud, said bottom projection having an axial length less than the axial depth of the first body member counterbore whereby the body members may simultaneously be threaded onto the same stud, tightened together by rotating the second body member against the top of the first body member and then counter-rotated to remove the stud by rotating the first body member.

10. The tool of claim 8 wherein the second body member bottom projection is cylindrical and includes a circumferential groove with an 0-ring to frictionally engage the axial counterbore.

11. The tool of claim 8 wherein the body members each have a hexagonal polygonal outer configuration.

12. A set of the tool of claim 8, claim 9, or claim 10 wherein each member of the set has a uniquely sized thread engaging bore.
